(19) United States
(12) Patent Application Publication
(10) Pub. No.: US 2013/0081470 A1
(43) Pub. Date: Apr. 4, 2013

(54) ULTRASONIC SENSOR AND METHOD FOR MANUFACTURING THE SAME

(71) Applicants: Boum Seock Kim, Gyunggi-do (KR); Jung Min Park, Gyunggi-do (KR); Eun Tae Park, Gyunggi-do (KR)

(72) Inventors: Boum Seock Kim, Gyunggi-do (KR); Jung Min Park, Gyunggi-do (KR); Eun Tae Park, Gyunggi-do (KR)

(73) Assignee: SAMSUNG ELECTRO-MECHANICS CO., LTD., Gyunggi-do (KR)

(21) Appl. No.: 13/328,187

(22) Filed: Dec. 16, 2011

(30) Foreign Application Priority Data
Sep. 29, 2011 (KR) 1020110099011

(51) Int. Cl. G01N 29/22; H04R 17/00

(52) U.S. Cl. 73/632; 29/25.35

(57) ABSTRACT

Disclosed herein are an ultrasonic sensor including: a cylindrical case; a piezoelectric element; a sound absorbing material; a temperature compensation capacitor inserted into and fixed to the groove; a first pin terminal connected to one electrode of the temperature compensation capacitor and an exposed electrode of the piezoelectric element while penetrating through the groove of the sound absorbing material; a second pin terminal inserted into and fixed to the groove of the sound absorbing material and connected to the other electrode of the temperature compensation capacitor; and a lead wire inserted into and fixed to the groove of the sound absorbing material and having one terminal connected to the second pin terminal and the other terminal connected to an inner wall of the case, and a method for manufacturing the same.

### CROSS REFERENCE TO RELATED APPLICATION

This application claims the benefit of Korean Patent Application No. 10-2011-0099011, filed on Sep. 29, 2011, entitled “Ultrasonic Wave Sensor and Manufacturing Method thereof”, which is hereby incorporated by reference in its entirety into this application.

### BACKGROUND OF THE INVENTION

1. Technical Field

The present invention relates to an ultrasonic sensor and a method for manufacturing the same.

2. Description of the Related Art

As known, when a ceramic element having piezoelectric and electrostrictive characteristics is used as a vibration source and electric energy having a high frequency is applied to the ceramic element, rapid vibration having the same number as the frequency is generated.

When the applied frequency is 20 kHz or more, the piezoelectric ceramic element generates an ultrasonic wave having a specific frequency band that may not be heard by people by vibration.

The ultrasonic wave generated through the piezoelectric ceramic element has been widely used for a sensor device measuring a shape or a distance of an object to be detected transmitting and receiving the ultrasonic wave, a detector, a washer, a medical diagnostic device/treatment device, skin care device, or the like.

Further, in the ultrasonic sensor using the ultrasonic wave, a scheme of using a flexible vibration mode by a metal thin plate and a piezoelectric ceramic, a scheme of using a mode by a natural frequency of a piezoelectric ceramic, and the like, are used.

In the case of the ultrasonic sensor according to the prior art, a piezoelectric ceramic having a lead wire connected by a soldering method is adhered to a bottom surface of a cavity part within an approximately cylindrical case having a step part formed at a central portion thereof as disclosed in Korean Patent Laid-Open Publication No. 2010-63866.

Further, a sound absorbing material is mounted on an upper side of the piezoelectric ceramic in order to prevent an ultrasonic wave from being propagated to the rear of a metal and prevent unnecessary vibration and noise.

A substrate is mounted in a state in which it is spaced apart from an upper surface of the sound absorbing material and includes a sealing material filled on an upper portion thereof in order to perform waterproof treatment, or the like.

In this structure, the lead wire is protruded to the outside through any through-hole formed in the sound absorbing material and the substrate in order to detect the ultrasonic wave from the piezoelectric ceramic.

When a voltage signal having the same frequency as a frequency determined according to a size (a thickness and a diameter) of a cylindrical case and characteristics of the piezoelectric ceramic is applied to the ultrasonic sensor according to the prior art having the above-mentioned structure, a metal plate to which the piezoelectric ceramic is adhered is vibrated, such that an ultrasonic wave corresponding to the frequency is generated.

The ultrasonic sensor includes a temperature compensation capacitor positioned at the center of the substrate in order to lower a change in sensitivity according to an external temperature.

It is difficult to treat the ultrasonic sensor according to the prior art in view of a device due to positions of the substrate and the temperature compensation capacitor. Therefore, it is significantly difficult to mass-produce and automatically produce the ultrasonic sensor.

In addition, a soldering process which is most difficult in view of mass-production and automatic-production among all processes is performed five times, thereby making it further difficult to mass-produce and automatically produce the ultrasonic sensor.

### SUMMARY OF THE INVENTION

The present invention has been made in an effort to provide an ultrasonic sensor capable of being mass-produced and automatically produced by having a structure in which a wire and a capacitor are inserted into a sound absorbing material to reduce the number of processes by soldering work, and a method for manufacturing the same.

According to a first preferred embodiment of the present invention, there is provided an ultrasonic sensor including: a cylindrical case having a bottom surface; a piezoelectric element formed on the bottom surface of the case; a sound absorbing material press-fitted into and fixed to an opening part and including a groove formed therein; a temperature compensation capacitor inserted into and fixed to the groove; a first pin terminal connected to one electrode of the temperature compensation capacitor and an exposed electrode of the piezoelectric element while penetrating through the groove of the sound absorbing material; a second pin terminal inserted into and fixed to the groove of the sound absorbing material and connected to the other electrode of the temperature compensation capacitor; and a lead wire inserted into and fixed to the groove of the sound absorbing material and having one terminal connected to the second pin terminal and the other terminal connected to an inner wall of the case.

The capacitor may include a pair of protrusions protruded from both sides thereof, the sound absorbing material may include a pair of protrusion fitting grooves formed at positions corresponding to those of the protrusions of the capacitor, and the protrusions of the capacitor may be fitted into and fixed to the protrusion fitting grooves of the sound absorbing material.

The sound absorbing material may be made of non-woven or cork.

The sound absorbing material may include a pair of fixing grooves having the first and second pin terminals inserted thereinto and fixed thereto, and each of the first and second pin terminals may be inserted into and fixed to the pair of fixing grooves.

The case may include a step part formed at a central point thereof, and the sound absorbing material may be closely adhered and fixed to the step part of the case.

The case may include a step part formed at a central point thereof, the sound absorbing material may include a step part formed corresponding to the step part of the case, and the step part of the sound absorbing material may be closely adhered and fixed to the step part of the case.

The ultrasonic sensor may further include an expandable resin formed between the bottom surface of the case and the sound absorbing material.

According to a second preferred embodiment of the present invention, there is provided a method for manufacturing an ultrasonic sensor, the method including: (A) disposing a piezoelectric element on a bottom surface of an inner portion of a cylindrical case; (B) fixing a sound absorbing material having a capacitor provided in a groove thereof to an opening part of the case; (C) inserting a first pin terminal to the groove of the sound absorbing material to thereby connect the first pin terminal to the capacitor and an exposed electrode of a piezoelectric element; (D) inserting a second pin terminal to the groove of the sound absorbing material to thereby connect the second pin terminal to the capacitor; and (E) inserting a lead wire into the groove of the sound absorbing material to thereby connect one terminal of the lead wire to an inner wall of the case and connect the other terminal thereof to the second pin terminal.

The step (B) may include: (B-1) arranging the center axis of the case and the center axis of the sound absorbing material so as to coincide with each other; (B-2) press-fitting and fixing the sound absorbing material into an opening part of the case; and (B-3) inserting and fixing the capacitor into the groove of the sound absorbing material.

The step (B) may further include (B-4) applying an adhesive to both sides of the capacitor before the step (B-2).

The step (B) may include: (B-1′) inserting and fixing the capacitor into the groove of the sound absorbing material; (B-2′) arranging the center axis of the case and the center axis of the sound absorbing material so as to coincide with each other; and (B-3′) press-fitting and fixing the sound absorbing material into the opening part of the case.

The method may further include (F) filling an expandable resin in an inner portion of the case through the groove of the sound absorbing material.

### BRIEF DESCRIPTION OF THE DRAWINGS

FIG. 1 is a transparent perspective view showing an ultrasonic sensor according to a first preferred embodiment of the present invention;

FIG. 2 is a transparent perspective view showing an ultrasonic sensor according to a second preferred embodiment of the present invention;

FIG. 3 is a transparent perspective view showing an ultrasonic sensor according to a third preferred embodiment of the present invention;

FIG. 4 is a perspective view of the temperature compensation capacitor of FIG. 1;

FIG. 5 is a perspective view of the sound absorbing material of FIG. 1; and

FIGS. 6 to 9 are process views showing a method for manufacturing an ultrasonic sensor according to the first preferred embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

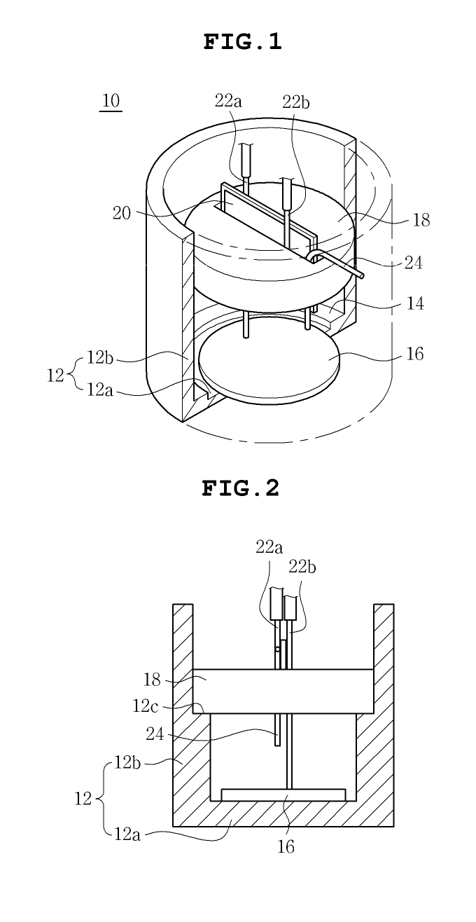

FIG. 1 is a transparent perspective view showing an ultrasonic sensor according to a first preferred embodiment of the present invention.

The ultrasonic sensor 10 shown in FIG. 1 includes, for example, a cylindrical case 12 having a bottom surface.

This case 12 is configured of a disk-shaped bottom surface part 12a and a cylindrical sidewall 12b. The case 12 is made of a metal material such as aluminum, or the like.

The case 12 may further include a step part 12c as shown in FIG. 2.

The step part 12c included in the case 12 as described above allows a piezoelectric element 16 and a sound absorbing material 18 to maintain a predetermined distance therebetween when the sound absorbing material 18 is press-fitted into and fixed to the case 12.

Therefore, a length of a pin terminal 22a positioned at a cavity part 14 while penetrating through the sound absorbing material 18 may be controlled to be a predetermined length.

In addition, the step part 12c included in the case 12 allows the sound absorbing material 18 to be closely adhered and fixed thereto when the sound absorbing material 18 is press-fitted into and fixed to the case 12, thereby making it possible to maintain parallelism of the sound absorbing material 18.

Further, when the step part 12c supports a lower surface of the sound absorbing material 18 as described above, the sound absorbing material 18 may be maintained in a stable state with respect to vibration or impact applied to the outside thereto.

Meanwhile, the cavity part 14 of an inner side of the case 12 is formed so that a cross section thereof has a circular shape, for example.

Since a spreading scheme of an ultrasonic wave radiated from the ultrasonic sensor 10 is determined according to the shape of the cavity part 14, the cavity part 14 may be changed in design so that a cross section thereof has other shapes such as an approximately oval shape, or the like, according to desired characteristics.

In an inner portion of the case 12, the bottom surface part 12a includes the piezoelectric element 16 adhered to an inner portion thereof.

The piezoelectric element 16 is formed by forming electrodes on both main surfaces of a piezoelectric substrate having, for example, a disk shape.

In addition, the electrode on one main surface side of the piezoelectric element 16 is adhered to the bottom surface part 12a by a conductive adhesive, or the like.

The sound absorbing material 18 made of, for example, non-woven, cork, or the like, is adhered to a cross section of an opening part of the case 12.

As a material of the sound absorbing material 18, a material having elasticity such as a silicon rubber, a resin, or the like, may be used. However, it is more preferable that non-woven, cork, or the like, is used since a number of air bubbles, or the like, need to be formed in order to satisfactorily absorb sound.

The sound absorbing material 18 is to suppress propagation of unnecessary vibration from the case 12 or the piezoelectric element 16 to the outside and suppress invasion of unnecessary vibration from the outside to the case 12 or the piezoelectric element 16.

The sound absorbing material 18 is formed in, for example, a disk shape having an outer diameter that is slightly smaller than an outer diameter of the case 12 but is slightly larger than an inner diameter of the case 12.

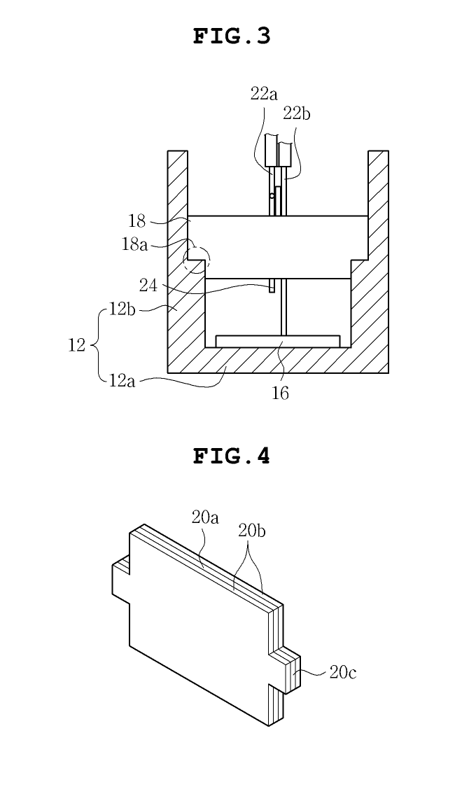

This sound absorbing material 18 may have a step part 18a corresponding to the step part 12c formed in the case 12, as shown in FIG. 3.

In the case in which the step part 18a is formed in the sound absorbing material 18 as described above, when the sound absorbing material 18 is press-fitted into and fixed to the case 12, the sound absorbing material 18 is firmly fixed thereto, such that it may be maintained in a stable state with respect to external vibration, impact, or the like.

In addition, the sound absorbing material 18 is disposed so that the center thereof is positioned on the same straight line as the center of the case 12 while an outer circumferential portion thereof on one main surface thereof faces a cross section of the opening part of the case 12. That is, the sound absorbing material 18 is formed to cover the opening part of the case 12.

The sound absorbing material 18 includes a groove 18a formed therein so as to be in communication with the cavity part 14 of the case 12 while vertically penetrating through both main surfaces thereof.

The sound absorbing material 18 includes a temperature compensation capacitor 20 inserted into and mounted in the groove 18a thereof.

When the temperature compensation capacitor 20 is inserted into and mounted in the groove 18a of the sound absorbing material 18, the temperature compensation capacitor 20 may be firmly fixed to the groove 18a of the sound absorbing material 18 by an adhesive.

Alternatively, when the temperature compensation capacitor 20 is inserted into and mounted in the groove 18a of the sound absorbing material 18, the temperature compensation capacitor 20 may be firmly fixed to the groove 18a of the sound absorbing material 18 by an adhesive film instead of the adhesive.

In addition, the sound absorbing material 18 includes pin terminals 22a and 22b each press-fitted into and fixed to the groove 18a thereof.

In this case, one end portions of these pin terminals 22a and 22b are disposed at one main surface side, that is, an inner side, of the sound absorbing part 18, such that they are disposed at the cavity part 14.

The other end portions of the pin terminals 22a and 22b are disposed at another main surface side, that is, an outer side, of the sound absorbing material 18.

Any one 22b of these pin terminals 22a and 22b is disposed to be long at one main surface side, that is, an inner side, of the sound absorbing material 18, such that one end thereof is connected to an electrode on an exposed main surface side of the piezoelectric element 16.

Although the pin terminals 22a and 22b are formed in a linear shape, they may also be bent to be curved.

In addition, the pin terminals 22a and 22b may include a coating material such as a rubber to allow an inner portion thereof to be protected from an outer portion thereof.

Meanwhile, one end of a lead wire 24 formed of, for example, a polyurethane copper wire is connected as a connection member to an inner surface of the sidewall 12b of the case 12.

Therefore, the lead wire 24 is electrically connected to the electrode on one main surface side of the piezoelectric element 16 through the case 12.

In addition, the other end of the lead wire 24 is inserted into and fixed to the groove 18a of the sound absorbing material 18 to thereby be connected to one end portion of the one pin terminal 22b.

Therefore, the electrode on one main surface side of the piezoelectric element 16 is electrically connected to one pin terminal 22b through the case 12 and the lead wire 24.

Next, the inner portion of the case 12 and the groove 18a of the sound absorbing material 18 are filled with an expandable resin 26 such as expandable silicon, or the like.

Since the expandable resin 26 is filled in a state in which horizontal characteristics are maintained by disposing the sound absorbing material 18 at the cross section of the case 12, it is possible to prevent position deviation, or the like, of front end portions of the pin terminals 22a and 22b.

In addition, the sound absorbing material 18 is positioned at the cross section side of the opening part of the case 12, such that it is supported and fixed from the inner portion of the case 12 by the expandable resin 26, thereby making it possible to stably maintain position precision of the pin terminals 22a and 22b even though stress is applied form the outside thereto, simultaneously with the horizontal characteristics thereof.

Next, the temperature compensation capacitor 20, which is to reduce a change in sensitivity according to an external temperature, includes a dielectric layer 20a and terminal electrodes 20b positioned on both sides of the dielectric layer 20a, as shown in FIG. 4.

The dielectric layer 20a is formed by sintering a ceramic green sheet containing a dielectric ceramic such as a BaTiO₃ based dielectric ceramic, a Ba(Ti,Zr)O₃ based dielectric ceramic, or (Ba,Ca)TiO₃ based dielectric ceramic.

The terminal electrodes 20b are formed by providing conductive pastes containing, for example, conductive powders and glass frit on both surfaces of the dielectric layer 20a and sintering the conductive pastes.

Plating layers may be formed on surfaces of the sintered terminal electrodes 20b as needed. The conductive pastes may be provided by, for example, an immersion method.

The temperature compensation capacitor 20 is press-fitted into and fixed to the groove 18a of the sound absorbing material 18. Here, in order to raise a fixed degree, the temperature compensation capacitor 20 may include protrusions 20c formed at both sides thereof.

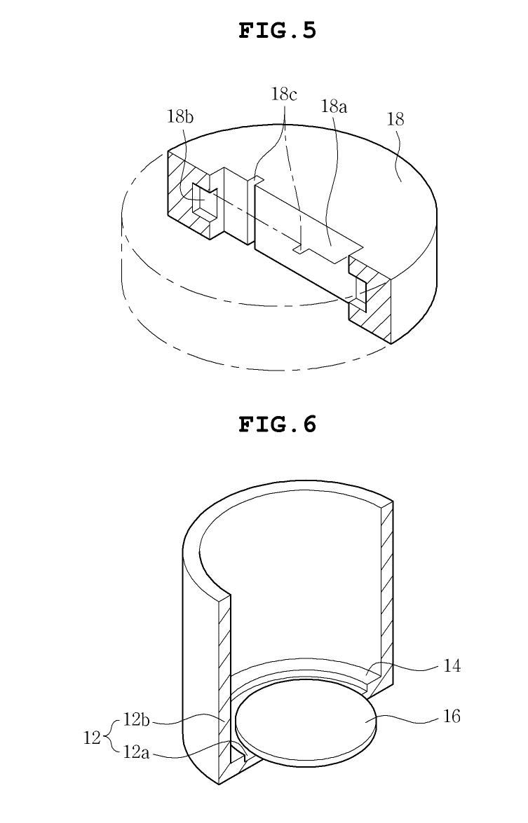

These protrusions 20c are fitted into protrusion fitting grooves 18b formed at both side of an inner portion of the groove 18a of the sound absorbing material 18 as shown in FIG. 5 to thereby firmly fix the temperature compensation capacitor 20 to the sound absorbing material 18.

The sound absorbing material 18 further includes terminal fixing grooves 18c to thereby allow the pin terminals 22a and 22b to be firmly fixed to a desired position when the pin terminals 22a and 22b are inserted into the sound absorbing material and fixed thereto.

When the ultrasonic sensor 10 having the above-mentioned configuration is used as, for example, a back sonar of a vehicle, or the like, driving voltage is applied to the pin terminals 22a and 22b, such that the piezoelectric element 16 is vibrated.

The bottom surface part 12a of the case 12 is also vibrated by the vibration of the piezoelectric element 16, such that an ultrasonic wave is radiated in a direction perpendicular to the bottom surface part 12a.

When the ultrasonic wave radiated from the ultrasonic sensor 10 is reflected from an object to be detected to thereby arrive at the ultrasonic sensor 10, the piezoelectric element 16 is vibrated, such that the ultrasonic wave is converted into an electrical signal and the electrical signal is output from the pin terminals 22a and 22b.

Therefore, a time from application of the driving voltage to the output of the electrical signal is measured, thereby making it possible to measure a distance from the ultrasonic sensor 10 to the object to be detected.

The ultrasonic sensor 10 has a structure in which the pin terminals 22a and 22b, the lead wire 24, the capacitor 20, and the like, are inserted into the sound absorbing material 18 to reduce the number of processes by soldering work, such that it may be mass-produced.

In addition, the ultrasonic sensor 10 has a structure in which the pin terminals 22a and 22b, the lead wire 24, the capacitor 20, and the like, are inserted into the sound absorbing material 18 to reduce the number of processes by soldering work, such that it may be automatically produced.

In the ultrasonic sensor 10, vibration of the entire case 12 may be suppressed by the expandable resin 26 uniformly filled in the inner portion of the case 12.

Further, in the ultrasonic sensor 10, since vibration interference between the case 12 and the pin terminals 22a and 22b such as propagation of vibration from the case 12 to the pin terminals 22a and 22b, or the like, is reduced or blocked by the sound absorbing material 18 or the expandable resin 26, an influence of a vibration leakage signal on a reverberation signal or a reception signal at the time of detection of the object, is suppressed. That is, reverberation characteristics due to vibration leakage, or the like, are not deteriorated. Furthermore, an influence of propagation of unnecessary vibration, or the like, from the outside through the pin terminals 22a and 22b is also suppressed.

In addition, in the ultrasonic sensor 10, since the case 12 or the piezoelectric 16 is not almost displaced with respect to the pin terminals 22a and 22b even though the pin terminals 22a and 22b are pushed from, for example, a ceiling surface (a piezoelectric element 16 side) after being mounted, large stress or displacement is not generated in electrical connection parts of the pin terminals 22a and 22b in the inner portion, such that it is difficult that a defect such as disconnection, or the like, is generated.

FIGS. 6 to 9 are process views showing a method for manufacturing an ultrasonic sensor according to the first preferred embodiment of the present invention.

Referring to FIG. 6, first, the case 12 and the piezoelectric element 16 are prepared, and the piezoelectric element 16 is fixed to the prepared case 12.

This case 12 is configured of the disk-shaped bottom surface part 12a and the cylindrical sidewall 12b and is made of the metal material such as aluminum, or the like.

In addition, the piezoelectric element 16 is formed by forming electrodes on both main surfaces of a piezoelectric substrate having, for example, a disk shape.

In this configuration, the electrode on one main surface side of the piezoelectric element 16 is adhered to the bottom surface part 12a by a conductive adhesive, or the like.

Particularly, the piezoelectric element 16 is fixed to the bottom surface part 12a of the case 12 by a conductive adhesive, or the like.

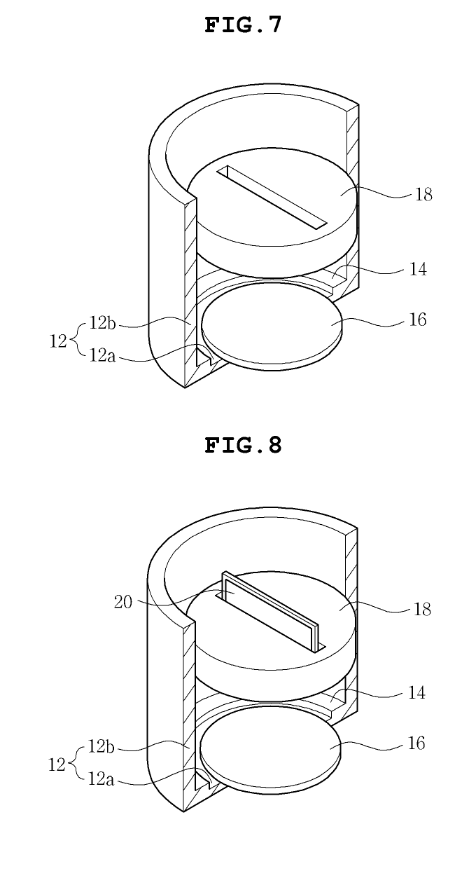

Then, as shown in FIG. 7, the sound absorbing material 18 having the groove is prepared. The sound absorbing material 18 is disposed so that the center thereof is positioned on the same straight line as the center of the case 12 while an outer circumferential portion thereof on one main surface thereof faces a cross section of the opening part of the case 12 and is press-fitted into the case 12 to thereby cover the opening part of the case 12.

The sound absorbing material 18 is formed in, for example, a disk shape having an outer diameter that is slightly smaller than an outer diameter of the case 12 but is slightly larger than an inner diameter of the case 12, and is made of non-woven, cork, or the like.

An adhesive is applied along an outer peripheral surface of the sound absorbing material 18 and the sound absorbing material 18 is then press-fitted into and fixed to the case 12, such that the sound absorbing material 18 may be firmly fixed to the case 12.

Further, in an example of the method for manufacturing an ultrasonic sensor, the temperature compensation capacitor 20 is completely press-fitted into the groove 18a after the sound absorbing material 18 is temporarily attached to the case 12, as shown in FIG. 8.

However, unlike the above-mentioned case, after the temperature compensation capacitor 20 is completely inserted into the groove 18a of the sound absorbing material 18, the sound absorbing material 18 may also be press-fitted into and adhered to the case 12.

The temperature compensation capacitor 20, which is to reduce a change in sensitivity according to an external temperature, includes the dielectric layer 20a and the terminal electrodes 20b positioned on both sides of the dielectric layer 20a and is provided with the protrusions 20c.

When the protrusions 20c are formed in the temperature compensation capacitor 20 as described above, the temperature compensation capacitor 20 and the sound absorbing material 18 are aligned and assembled to each other so that the protrusions 20c are inserted into and mounted in the protrusion fitting grooves 18b of the sound absorbing material 18.

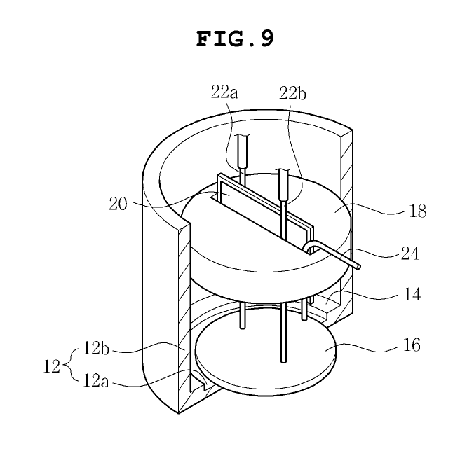

Then, as shown in FIG. 9, the pin terminals 22a and 22b are press-fitted into and fixed to the sound absorbing material 18. In addition, the lead wire 24 is also press-fitted thereinto and fixed thereto.

Here, one 22b of the pint terminals 22a and 22b is electrically connected to the electrode on the exposed main surface side of the piezoelectric electrode 16.

In order to maintain an electrically excellent connection state between the pin terminals 22a and 22b and the electrode on the exposed main surface side of the piezoelectric element 16, a conductive adhesive is applied to the electrode on the exposed main surface side of the piezoelectric element 16, thereby making it possible to increase adhesion.

Then, the expandable silicon before being expanded is introduced into the inner portion of the case 12 and the introduced expandable silicon is heated, expanded, and cured, such that the expandable silicon 26 is filled in the inner portion of the case 12, or the like.

In this case, since an extra expandable silicon is pushed from the groove 18a to the outside, the expandable silicon 26 is pushed and spread at the inner portion of the case 12 as an appropriate internal pressure, such that the expandable resin 26 may be uniformly filled in the inner portion of the case 12 simultaneously with being filled up to corner portions of the inner portion of the case 12. The ultrasonic sensor 10 is manufactured as described above.

In the method for manufacturing an ultrasonic sensor 10, the pin terminals 22a and 22b, the lead wire 24, the capacitor 20, and the like, are inserted into the sound absorbing material 18 to reduce the number of processes by soldering work, thereby making it possible to mass-produce the ultrasonic sensor 10.

Further, in the method for manufacturing an ultrasonic sensor 10, the pin terminals 22a and 22b, the lead wire 24, the capacitor 20, and the like, are inserted into the sound absorbing material 18 to reduce the number of processes by soldering work, thereby making it possible to automatically produce the ultrasonic sensor 10.

In addition, in the method for manufacturing an ultrasonic sensor 10, the sound absorbing material 18 is positioned at the cross section side of the opening part of the case 12, such that it is supported and fixed from the inner portion of the case 12 by the expandable resin 26, thereby making it possible to stably maintain position precision of the pin terminals 22a and 22b even though stress is applied form the outside thereto, simultaneously with the horizontal characteristics thereof.

In the ultrasonic sensor 10, vibration of the entire case 12 may be suppressed by the expandable resin 26 uniformly filled in the inner portion of the case 12.

According to the preferred embodiments of the present invention, the wire and the capacitor are inserted into the sound absorbing material to reduce the number of processes by soldering work, thereby making it possible to mass-produce the ultrasonic sensor.

In addition, the wire and the capacitor are inserted into the sound absorbing material to reduce the number of processes by soldering work, thereby making it possible to automatically produce the ultrasonic sensor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An ultrasonic sensor comprising:
a cylindrical case having a bottom surface;
a piezoelectric element formed on the bottom surface of the case;
a sound absorbing material press-fitted into and fixed to an opening part and including a groove formed therein;
a temperature compensation capacitor inserted into and fixed to the groove;
a first pin terminal connected to one electrode of the temperature compensation capacitor and an exposed electrode of the piezoelectric element while penetrating through the groove of the sound absorbing material;
a second pin terminal inserted into and fixed to the groove of the sound absorbing material and connected to the other electrode of the temperature compensation capacitor; and
a lead wire inserted into and fixed to the groove of the sound absorbing material and having one terminal connected to the second pin terminal and the other terminal connected to an inner wall of the case.

2. The ultrasonic sensor as set forth in claim 1, wherein the capacitor includes a pair of protrusions protruded from both sides thereof,
the sound absorbing material includes a pair of protrusion fitting grooves formed at positions corresponding to those of the protrusions of the capacitor, and
the protrusions of the capacitor are fitted into and fixed to the protrusion fitting grooves of the sound absorbing material.

3. The ultrasonic sensor as set forth in claim 1, wherein the sound absorbing material is made of non-woven or cork.

4. The ultrasonic sensor as set forth in claim 1, wherein the sound absorbing material includes a pair of fixing grooves having the first and second pin terminals inserted thereinto and fixed thereto, and
each of the first and second pin terminals is inserted into and fixed to the pair of fixing grooves.

5. The ultrasonic sensor as set forth in claim 1, wherein the case includes a step part formed at a central point thereof, and
the sound absorbing material is closely adhered and fixed to the step part of the case.

6. The ultrasonic sensor as set forth in claim 1, wherein the case includes a step part formed at a central point thereof,
the sound absorbing material includes a step part formed corresponding to the step part of the case, and
the step part of the sound absorbing material is closely adhered and fixed to the step part of the case.

7. The ultrasonic sensor as set forth in claim 1, further comprising an expandable resin formed between the bottom surface of the case and the sound absorbing material.

8. A method for manufacturing an ultrasonic sensor, the method comprising:
(A) disposing a piezoelectric element on a bottom surface of an inner portion of a cylindrical case;
(B) fixing a sound absorbing material having a capacitor provided in a groove thereof to an opening part of the case;
(C) inserting a first pin terminal to the groove of the sound absorbing material to thereby connect the first pin terminal to the capacitor and an exposed electrode of a piezoelectric element;
(D) inserting a second pin terminal to the groove of the sound absorbing material to thereby connect the second pin terminal to the capacitor; and
(E) inserting a lead wire into the groove of the sound absorbing material to thereby connect one terminal of the lead wire to an inner wall of the case and connect the other terminal thereof to the second pin terminal.

9. The method as set forth in claim 8, wherein the step (B) includes:
(B-1) arranging the center axis of the case and the center axis of the sound absorbing material so as to coincide with each other;
(B-2) press-fitting and fixing the sound absorbing material into an opening part of the case; and
(B-3) inserting and fixing the capacitor into the groove of the sound absorbing material.

10. The method as set forth in claim 9, wherein the step (B) further includes (B-4) applying an adhesive to both sides of the capacitor before the step (B-2).

11. The method as set forth in claim 8, wherein the step (B) includes:
(B-1′) inserting and fixing the capacitor into the groove of the sound absorbing material;
(B-2′) arranging the center axis of the case and the center axis of the sound absorbing material so as to coincide with each other; and
(B-3′) press-fitting and fixing the sound absorbing material into the opening part of the case.

12. The method as set forth in claim 8, further comprising (F) filling an expandable resin in an inner portion of the case through the groove of the sound absorbing material.
